(19) United States
(12) Patent Application Publication
(10) Pub. No.: US 2019/0327246 A1
(43) Pub. Date: Oct. 24, 2019

(54) Information Security Verification Method and Terminal

(71) Applicant: Huawei Technologies Co., Ltd., Shenzhen (CN)

(72) Inventors: Shanxi Chen, Shenzhen (CN); Bailin Wen, Hangzhou (CN)

(21) Appl. No.: 16/458,718

(22) Filed: Jul. 1, 2019

Related U.S. Application Data
(63) Continuation of application No. PCT/CN2017/118653, filed on Dec. 26, 2017.

(30) Foreign Application Priority Data
Dec. 30, 2016 (CN) 201611265761.5

(51) Int. Cl. H04L 29/06

(52) U.S. Cl. CPC H04L 63/126

(57) ABSTRACT

An information security verification method comprises obtaining, by a terminal, abstract information of to-be-verified information and an identification code, where the identification code is used to identify a sender that sends the to-be-verified information to the terminal, then sending an information security verification request to the sender of the to-be-verified information based on the identification code, where the information security verification request includes the abstract information of the to-be-verified information, and finally receiving a verification result from the sender, where the verification result indicates whether the sender has ever sent information same as the to-be-verified information.

### CROSS-REFERENCE TO RELATED APPLICATIONS

This application is a continuation of International Application No. PCT/CN2017/118653, filed on Dec. 26, 2017, which claims priority to Chinese Patent Application No.201611265761.5, filed on Dec. 30, 2016. The disclosures of the aforementioned applications are hereby incorporated by reference in their entireties.

### TECHNICAL FIELD

The present disclosure relates to the information security field, and in particular, to an information security verification method and a terminal.

### BACKGROUND

In recent years, with rapid development of a short message service, criminals in the society use short messaging service (SMS) messages to conduct illegal activities. For example, SMS messages are frequently used for money defrauding, imposing quite negative impacts on the society. To conduct fraud, the criminals usually send tempting fake information such as a prize-winning, a commodity tax rebate, and a low-priced sale of vehicle, or send fake information indicating that a bank card or a credit card of a terminal user has an abnormal cash payment or abnormal cash consumption, and then defraud the user step by step when the user replies an SMS message or calls back for enquiry. Because terminal SMS messages spread widely, frauds can easily expand a spreading scope of a fraud SMS message, thereby increasing a fraud success rate. Although the news media and public security department keep reminding the public to remain vigilant, the public still lacks an approach and a means to identify illegal SMS messages.

### SUMMARY

Embodiments of the present disclosure provide an information security verification method and a terminal, to accurately and quickly implement security verification on information received by the terminal.

According to a first aspect, a terminal is provided, where the terminal includes a communications apparatus configured to send and receive information, a data storage apparatus, and an information security verification apparatus. The data storage apparatus is configured to store historical information that is received and sent by the communications apparatus. The information security verification apparatus is configured to obtain abstract information of to-be-verified information and an identification code from the historical information that is received by the communications apparatus or stored in the data storage apparatus of the terminal, where the identification code is used to identify a sender that sends the to-be-verified information to the terminal. The communications apparatus is further configured to send an information security verification request to the sender and receive a verification result from the sender, where the information security verification request includes the abstract information of the to-be-verified information, and the verification result is used to indicate whether the sender has ever sent information same as the to-be-verified information.

With reference to the first aspect, in a first implementation of the first aspect, the terminal further includes a to-be-verified identification code list, and the to-be-verified identification code list stores an identification code that needs to be verified.

With reference to the first aspect or the first implementation of the first aspect, in a second implementation of the first aspect, the security apparatus is configured to initiate the information security verification request when the terminal receives information from a sender identified by the identification code that needs to be verified in the to-be-verified identification code list.

With reference to the first aspect, the first implementation of the first aspect, or the second implementation of the first aspect, in a third implementation of the first aspect, the abstract information is information generated based on key information in the to-be-verified information, and is used to represent the to-be-verified information.

With reference to any one of the first aspect or the foregoing three implementations of the first aspect, in a fourth implementation of the first aspect, the information security verification apparatus is configured to negotiate a generation manner of the abstract information of the to-be-verified information with a server, and generate the abstract information based on the negotiated generation manner of the abstract information and the to-be-verified information, where the server is the sender identified by the to-be-verified identification code in the to-be-verified identification code list.

With reference to any one of the first aspect or the foregoing four implementations of the first aspect, in a fifth implementation of the first aspect, the data storage apparatus is configured to store a server list, the server list includes an identification code, a server, and an address of the server, and the server is the sender identified by the to-be-verified identification code in the to-be-verified identification code list, and the information security verification apparatus is configured to obtain, based on the identification code and the server list, an address of a server corresponding to the identification code to send the information security verification request to the server using the communications apparatus based on the address of the server.

A second aspect provides an information security verification method, where the method includes obtaining, by a terminal, abstract information of to-be-verified information and an identification code, where the identification code is used to identify a sender that sends the to-be-verified information to the terminal, then sending an information security verification request to the sender of the to-be-verified information based on the identification code, where the information security verification request includes the abstract information of the to-be-verified information, and finally receiving a verification result from the sender, where the verification result indicates whether the sender has ever sent information same as the to-be-verified information.

With reference to the second aspect, in a first implementation of the second aspect, before the obtaining abstract information of to-be-verified information and an identification code, the method further includes determining, based on a to-be-verified identification code list, whether information received by the terminal is the to-be-verified information, where the to-be-verified identification code list stores an identification code that needs to be verified.

With reference to the second aspect or the first implementation of the first aspect, in a second implementation of the second aspect, the determining, based on a to-be-verified identification code list, whether information received by the terminal is the to-be-verified information, where the to-be-verified identification code list stores an identification code that needs to be verified includes, when the terminal receives the information, extracting a sender identification code carried in the information, and determining whether the sender identification code is recorded in the to-be-verified identification code list, where the information is the to-be-verified information if the sender identification code is recorded in the to-be-verified identification code list.

With reference to the second aspect or the first or the second implementation of the second aspect, in a third implementation of the second aspect, before the obtaining abstract information of to-be-verified information and an identification code, the method includes negotiating a generation manner of the abstract information of the to-be-verified information with a server, and generating the abstract information based on the negotiated abstract information generation manner and the to-be-verified information, where the server is a sender identified by the to-be-verified identification code in the to-be-verified identification code list.

With reference to any one of the second aspect or the foregoing implementations of the second aspect, in a fourth implementation of the second aspect, the sending an information security verification request to the sender of the to-be-verified information based on the identification code includes obtaining, based on the identification code and a server list, an address of a server corresponding to the identification code to send the information security verification request to the server based on the address of the server, where the server list is pre-stored in the terminal, and the server list includes an identification code, a server, and the address of the server, where the server is a sender identified by the to-be-verified identification code in the to-be-verified identification code list.

A third aspect provides an information verification system, including a terminal and a server. The terminal is configured to receive information sent by the server and send an information security verification request to the server based on an identification code carried in the information. The information security verification request includes abstract information of to-be-verified information. The server is configured to receive the information security verification request, perform matching on the abstract information of the to-be-verified information included in the information security verification request and historical record data stored in the server, where the historical record data is historical information that is sent out by the server, and send a verification result to the terminal, where the verification result indicates whether the server has ever sent information same as the to-be-verified information.

With reference to the third aspect, in a first implementation of the third aspect, the terminal further includes a to-be-verified identification code list, and the to-be-verified identification code list stores an identification code that needs to be verified.

With reference to the first implementation of the third aspect, in a second implementation of the third aspect, the terminal is configured to initiate the information security verification request when the terminal receives information from a sender identified by the identification code that needs to be verified in the to-be-verified identification code list.

A fourth aspect provides a terminal, where the terminal includes a radio frequency (RF) circuit, configured to send and receive information, a memory, configured to store historical information that is received and sent by the RF circuit, and a processor. The processor is configured to obtain abstract information of to-be-verified information and an identification code from the RF circuit or the processor, where the identification code is used to identify a sender that sends the to-be-verified information to the terminal, and the RF circuit is further configured to send an information security verification request to the sender and receive a verification result from the sender, where the information security verification request includes the abstract information of the to-be-verified information, and the verification result is used to indicate whether the sender has ever sent information same as the to-be-verified information.

A fifth aspect provides a server, including a data storage apparatus, configured to store historical record data, where the historical record data is historical information that is sent out by the server, a communications apparatus, configured to receive an information security verification request sent by a terminal, where the information security verification request includes abstract information of to-be-verified information, and a verification apparatus, configured to perform matching on the historical record data and the abstract information of the to-be-verified information included in the information security verification request. The communications apparatus is further configured to send a verification result to the terminal, where the verification result indicates whether the server has ever sent information same as the to-be-verified information.

With reference to the fifth aspect, in a first implementation of the fifth aspect, the verification apparatus is configured to negotiate a generation manner of the abstract information of the to-be-verified information with the terminal. The verification apparatus is further configured to perform, based on the generation manner of the abstract information, matching on the abstract information of the to-be-verified information and the historical record data stored in the server.

In possible implementations of the present disclosure, the to-be-verified identification code list stored in the terminal may be used to identify the identification code that needs to be verified, the to-be-verified identification code list may be input by the user of the terminal in advance as required, or may be provided by a developer of a terminal operating system or a developer of the information security verification apparatus by pre-storing an identification code of a sending source of some important information such that the user of the terminal may perform management, such as addition or deletion. Based on a user-preset list of identification codes that need to be verified, a sending source of received important information may be selectively identified to avoid a waste of terminal resources due to verification of some unimportant information.

In possible implementations of the present disclosure, when negotiating the generation manner of the abstract information with the terminal, the server may specify the generation manner of the abstract information for the terminal, or may change the generation manner of the abstract information, for example, may specify or determine through negotiation to use a different abstract information generation manner in a different time period. The terminal may alternatively notify the server of a currently used abstract information generation manner such that the server learns of the abstract information generation manner, to identify content represented by the abstract information, for verification.

In the foregoing, the information security verification apparatus is disposed in the terminal, and using the identification code carried in the important information, the identification request is sent to the sending source identified by the important information to verify authenticity of a source of the important information.

### BRIEF DESCRIPTION OF DRAWINGS

FIG. 1 is a schematic diagram of an information verification system according to Embodiment 1 of the present disclosure.

FIG. 2 is a flowchart of an information security verification method according to Embodiment 2 of the present disclosure.

FIG. 3 is a schematic diagram of a terminal according to Embodiment 3 of the present disclosure.

### DESCRIPTION OF EMBODIMENTS

The technical solutions of the present disclosure are further described in detail with reference to accompanying drawings and embodiments as follows.

The embodiments of the present disclosure provide an information verification system, to identify, based on communication between a terminal and a server, a key part of visible content and determine a source to implement security verification on an information source and a nominal source.

The nominal source is a source that is identified and determined based on the key part of the visible content, and the nominal source uses identification information of a session initiator, a caller, a calling party, or a sender as a main identification object. For example, a sender number of an SMS message includes “10086”, or a calling number of an incoming call includes “10086”. In this case, a user may directly determine the incoming call and a source using an incoming number finally. When an incoming number is changeable or a rogue base station exists, accuracy of determining performed using the nominal source may be low, and subsequent actions based on the determining may have risks.

The information verification system provided in the embodiments of the present disclosure is mainly used for verifying an SMS message or an incoming call received by the terminal using the server. The terminal includes an information security verification apparatus, and the information security verification apparatus has permission to read specific target information from a call record and an SMS message record, for example, from a voice call record or an SMS message record. For example, based on a permission setting provided by the user, an information security verification apparatus of “China Mobile Communications” is set to have permission to read a nominal source call or SMS message using “10086” as a caller identifier. For example, an information security verification apparatus of “China Merchants Bank” is set to have permission to read a nominal source call or SMS message using “95555” as a caller identifier. Then, after the information security verification apparatus reads a voice call or an SMS message within corresponding permission, the information security verification apparatus forms a verification request using an information abstract as main content, and sends the verification request to a verification server using a data channel. The verification server stores communication records of voice calls or SMS messages of an initiator, and after receiving the verification request and an abstract of to-be-verified target information that are sent by the terminal, performs matching on the abstract of the target information and the stored historical communication records to check whether the abstract of the to-be-verified target information exists in the historical communication records, and sends a matching result to the terminal. If the abstract of the target information can match a stored historical communication record, it indicates that the to-be-verified target information is exactly sent by the verification server, or if the abstract of the target information fails to match a stored historical communication record, it indicates that the to-be-verified target information is not sent by the verification server, thereby implementing verification on a key voice call or SMS message received by the terminal.

For example, in actual application of some embodiments of the present disclosure, the terminal receives an SMS message from a sender xx95555xx, and the SMS message provides a link. Content of the link is to prompt a user to click the link and change a password to reinforce account security. Based on a nominal-source principle, this SMS message is marked as from “China Merchants Bank” because a sending source includes “95555”. Therefore, an SMS display interface displays “China Merchants Bank” as the sender of the SMS message. The information security verification apparatus of the terminal first forms a verification request message using a sending/receiving time of the SMS message, a receiver, all content of the SMS message or an abstract of content information, a content verification code generated using cyclic redundancy code (CRC) or in another abstract generation manner, or the like, and sends the verification request message to the server for verification. After completing the verification, the server sends a verification result to the information security verification apparatus of the terminal that initiates the verification request.

If the verification fails, the information security verification apparatus displays an alert “Danger” or “Fake information” on a user screen. Prompt information may be an alert such as “Security verification failed. This message is from an insecure source” to warn the user of a fraud and to provide further precautionary measures.

In actual application, the information security verification apparatus may be implemented using an independent application program APP to verify a capital-change-related voice call or SMS message from a bank, a securities company, an operator, an e-commerce merchant, or the like. The information security verification apparatus may be integrated into an application (APP) client of the bank, the securities company, the operator, the e-commerce merchant, or the like, to verify a voice call or an SMS message of a corresponding object. For example, an information security verification apparatus in a China Merchants Bank APP client verifies only information carrying a number related to China Merchants Bank, and an information security verification apparatus in China International Trust Investment Corporation (CITIC) Securities APP verifies only information carrying a number related to China CITIC Bank.

During installation of an information security verification apparatus or an APP client integrated with an information security verification apparatus, specific permission is required to be correspondingly set to read a corresponding characteristic. For example, SMS messages or calls corresponding to China Mobile Communications and China Merchants Bank are those including characteristic identification codes 10086 and 95555, respectively. The terminal itself may provide a verification triggering module in an SMS message or call function. For example, when an SMS message or a call is received, the verification triggering module extracts abstract information of the received SMS message or call, sends the information using a corresponding information security verification apparatus to a corresponding server for verification, and receives a verification result that includes at least an identifier “authentic” or “fake”.

### Embodiment 1

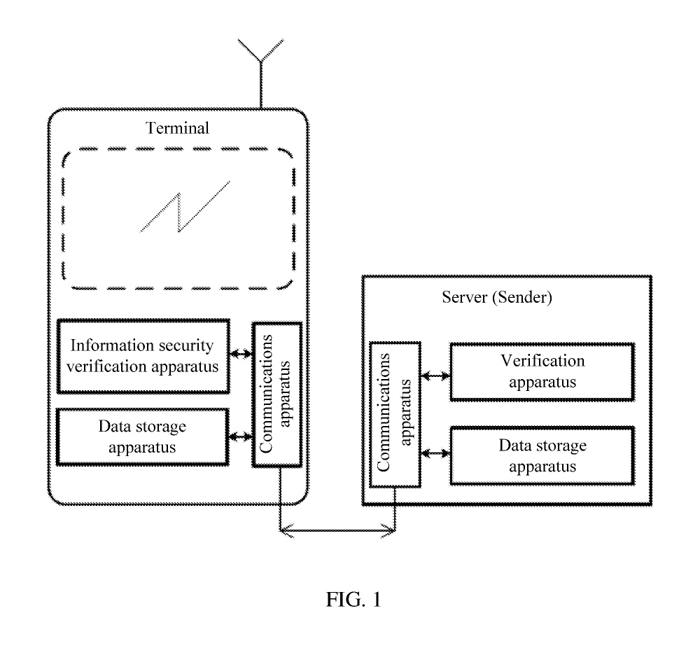

As shown in FIG. 1, an information verification system in Embodiment 1 of the present disclosure includes a terminal and a server. The terminal includes a communications apparatus, a data storage apparatus, and an information security verification apparatus, and the server includes a communications apparatus, a data storage apparatus, and a verification apparatus.

The communications apparatus of the terminal is configured to send and receive information, and the information includes an SMS message and voice message.

The data storage apparatus of the terminal is configured to store historical information that is received and sent by the communications apparatus.

The information security verification apparatus of the terminal is configured to obtain abstract information of to-be-verified information and an identification code from the historical information stored in the communications apparatus or the data storage apparatus of the terminal.

The abstract information may be information generated using key information extracted from the to-be-verified information, and is used to represent the to-be-verified information. In this case, when the to-be-verified information is excessively long, a data volume for information sending and storage is decreased. Before sending the information for security verification or before performing information security verification, the information security verification apparatus needs to negotiate a generation manner of the abstract information of the to-be-verified information with the server. The server is a sender identified by a to-be-verified identification code in a to-be-verified identification code list. In this way, the terminal generates abstract information D1 from the to-be-verified information in the negotiated generation manner of the abstract information such that the server can identify the abstract information D1 and reversely deduce content of the to-be-verified information based on the negotiated generation manner of the abstract information, thereby ensuring verifiability of the abstract information. For example, an abstract information generation manner negotiated with the server by a user of the terminal is ZC60 indicating that content of an SMS message is to indicate deduction of 60 yuan from an account of the user of the terminal. In addition, the server may generate same abstract information based on historical record data and the negotiated generation manner of the abstract information to match and verify the abstract information sent by the terminal.

In addition, during negotiation of the abstract information generation manner with the terminal, the server may specify the abstract information generation manner for the terminal, and may change the abstract information generation manner, for example, specify or negotiate to use a different abstract information generation manner in a different time period. The terminal may alternatively notify the server of a currently used abstract information generation manner such that the server learns of the abstract information generation manner, to identify content represented by the abstract information, for verification.

It is assumed that there is a set of abstract information generation manners, such as {DM1, DM2, DM3}. It can be ensured that compatible and even consistent abstract information can be generated for any source information regardless of whether the DM1 herein runs on the terminal or a verification server. As deduced by analogy, an abstract information generation manner specified by the server may be unique and remain unchanged within a lifecycle of an information security verification function, and the abstract information generation manner may be directly installed on the terminal using a verification security package or in another data form. The abstract information generation manner implemented in an installation manner usually remains unchanged. In some embodiments, alternatively, during installation of the information security verification apparatus on the terminal, a series of information abstract generation manners may be already included in a related installation package, and the server may merely need to specify the information abstract generation manner, or when the terminal sends an information security verification request to the server during information security verification, a current abstract generation number is carried.

The identification code is used to identify a sender that sends the to-be-verified information to the terminal. The to-be-verified information is information from a to-be-verified sender, and the to-be-verified sender includes a sender with a preset identification code. The preset identification code may be set by the user of the terminal as required, and the identification code may be generally set to be an identification code of a sending source, such as a bank, a securities company, or an operator. For example, an identification code of China Mobile Communications is 10086 and an identification code of China Merchants Bank is 95555.

The information security verification apparatus of the terminal may manage and store a to-be-verified identification code list, and the to-be-verified identification code list stores an identification code that needs to be verified. The information security verification apparatus initiates an information security verification request when the terminal receives information from a sender identified by the identification code that needs to be verified in the to-be-verified identification code list. The to-be-verified identification code list is input by the user of the terminal in advance as required, or may be a to-be-verified identification code list formed using sending source identification codes that are of some common important information and that are pre-stored by a developer of a terminal operating system or a developer of the information security verification apparatus. The user of the terminal performs management, for example addition or deletion, on the to-be-verified identification code list. It can be understood that the to-be-verified identification code list is not necessarily managed and stored by the information security verification apparatus, and may be managed and stored by another component of the terminal. This is also applicable to the embodiments of the present disclosure.

The information security verification apparatus of the terminal is configured to send the information security verification request to the server based on the identification code using the communications apparatus of the terminal. The server is a sender identified by the identification code, and the information security verification request includes the abstract information of the to-be-verified information.

The data storage apparatus of the terminal stores a server list that is maintained by the information security verification apparatus, and the server list is collected from various servers by the information security verification apparatus or a developer of the server list. As shown in Table 1, the server list includes a server identification code, a nominal source (a sender) corresponding to the server identification code, and an address of a server corresponding to the server identification code, and may further include some other information of the server. The server identification codes in the server list are also in the to-be-verified identification code list.

The information security verification apparatus of the terminal is further configured to obtain, based on the identification code and the server list, an address of a server corresponding to the identification code to send the information security verification request to the server based on the address of the server using the communications apparatus of the terminal.

TABLE 1

| Nominal- | | | |
|---|---|---|---|
| source | | | Other |
| characteristic | | | information |
| value | Nominal source | Server address | of a server |
| 95555 | China Merchants | {8.13.254.99, . . . } | Xxx |
| | Bank | | |
| 10086 | China Mobile | {192.222.254.19, . . . } | Yyy |
| | Communications | | |
| . . . | . . . | . . . | . . . |

The communications apparatus of the server is configured to receive the information security verification request.

The verification apparatus of the server is configured to perform matching on the abstract information of the to-be-verified information included in the information security verification request and the historical record data stored in the data storage apparatus of the server. The historical record data is a record of historical information sent out by the server, and the historical information record includes an SMS message record, a voice information record, and other information in various forms of text or multimedia.

The communications apparatus of the server is configured to send a matching result of the server to the terminal. The terminal may determine, using the matching result, whether the to-be-verified information is sent by the server identified by the identification code of the to-be-verified information. If the to-be-verified information is sent by the server identified by the identification code of the to-be-verified information, the to-be-verified information is “authentic”. If the to-be-verified information is not sent by the server identified by the identification code of the to-be-verified information, the to-be-verified information is “fake”. In this way, security verification on information exchanged between the terminal and the server is implemented.

In some embodiments of the present disclosure, the information security verification apparatus of the terminal may be an independent APP installed on the terminal, and a to-be-verified server identification code list may be preset and stored in the APP. The identification code list stores a server identification code that needs to be verified by the user of the terminal to determine, when the terminal receives information, whether the received information includes an identification code of a to-be-verified server. If the received information includes the identification code of the to-be-verified server, the APP may automatically initiate verification, or the user of the terminal may select whether to initiate verification. Whether the APP automatically initiates verification or the user of the terminal selects to initiate verification may be preset in an APP setting option by the user of the terminal.

In some embodiments of the present disclosure, the information security verification apparatus of the terminal may be integrated into an APP client of a bank, a securities company, an operator, an e-commerce merchant, or the like, to merely verify information received by the terminal and including a specific identification code, for example, a verification request apparatus in a China Merchants Bank APP client merely verify information carrying a number related to China Merchants Bank, such as information including “95555”, and a verification request apparatus in CITIC Securities APP merely verify information carrying a number related to China CITIC Bank.

In some embodiments of the present disclosure, the information security verification apparatus may be available as a pre-configuration of a terminal system, and a setting interface may also be provided to the user and/or a software developer for adding new security verification options. For example, a related function of the information security verification apparatus may be found in a security category of an operating system setting of the terminal. In this implementation, the related function of the information security verification apparatus in the operating system may be presetting some verification rules, for example, presetting some important commonly-used verification identification codes, such as an identification code 10086 of China Mobile Communications and an identification code 95555 of China Merchants Bank, in the terminal operating system as public verification options. In this implementation, when detecting that a sender carried with a preset identification code sends an SMS message or voice information to the terminal, the information security verification apparatus in the terminal operating system may select, based on a user setting, whether to initiate a verification procedure in the foregoing Embodiment 1.

In some embodiments of the present disclosure, the information security verification apparatus may be integrated into some third-party super APPs, for example, integrated into a WECHAT client, or provide a verification channel using a WECHAT public service platform. A specific working principle and method of the information security verification apparatus are the same as those of the foregoing Embodiment 1, and details are not described herein again.

### Embodiment 2

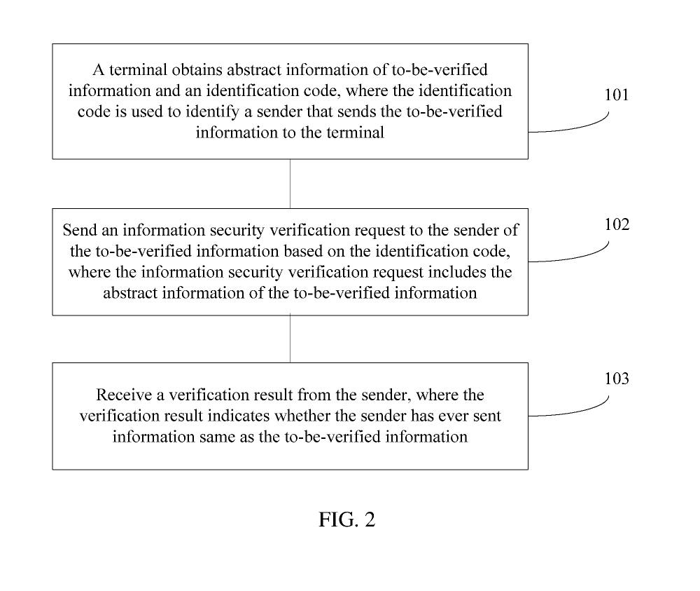

As shown in FIG. 2, an information security verification method in Embodiment 2 of the present disclosure is used to identify, based on communication between a terminal and a server, a key part of visible content and determine a source to implement security verification on an information source.

The information security verification method includes the following steps.

Step 101: A terminal obtains abstract information of to-be-verified information and an identification code, where the identification code is used to identify a sender that sends the to-be-verified information to the terminal.

Step 102: Send an information security verification request to the sender of the to-be-verified information based on the identification code, where the information security verification request includes the abstract information of the to-be-verified information.

Step 103: Receive a verification result from the sender, where the verification result indicates whether the sender has ever sent information same as the to-be-verified information.

Before step 101, or before the obtaining abstract information of to-be-verified information and an identification code, the method further includes determining, based on a to-be-verified identification code list, whether information received by the terminal is the to-be-verified information, where the to-be-verified identification code list stores an identification code that needs to be verified. The to-be-verified identification code list is input by a user of the terminal in advance as required, or may be a to-be-verified identification code list formed using sending source identification codes that are of some common important information and that are pre-stored by a developer of a terminal operating system or a developer of an information security verification apparatus. The user of the terminal performs management, for example addition or deletion, on the to-be-verified identification code list.

Before step 101, or before the obtaining abstract information of to-be-verified information and an identification code, the method further includes negotiating a generation manner of the abstract information of the to-be-verified information with a server, and generating the abstract information based on the negotiated abstract information generation manner and the to-be-verified information.

The terminal may negotiate the generation manner of the abstract information with the server, and determine the generation manner as a fixed abstract information generation manner. In this way, the information security verification request does not need to carry the abstract information generation manner used by the terminal. If the terminal negotiates a changeable abstract information generation manner with the server, the information security verification request needs to carry the abstract information generation manner used by the terminal.

In step 102, the sending an information security verification request to the sender of the to-be-verified information based on the identification code includes obtaining, based on the identification code and a server list, an address of a server corresponding to the identification code to send the information security verification request to the server based on the address of the server, where the server list is pre-stored in the terminal, and the server list is collected from various servers by the information security verification apparatus or a developer of the server list and stored in the terminal. The server list includes a server identification code, a nominal source (a sender) corresponding to the server identification code, and an address of a server corresponding to the server identification code, and may further include some other information of the server.

When the terminal receives information, the terminal extracts a sender identification code carried in the information, and determines whether the sender identification code is recorded in the to-be-verified identification code list. The information is the to-be-verified information if the sender identification code is recorded in the to-be-verified identification code list.

### Embodiment 3

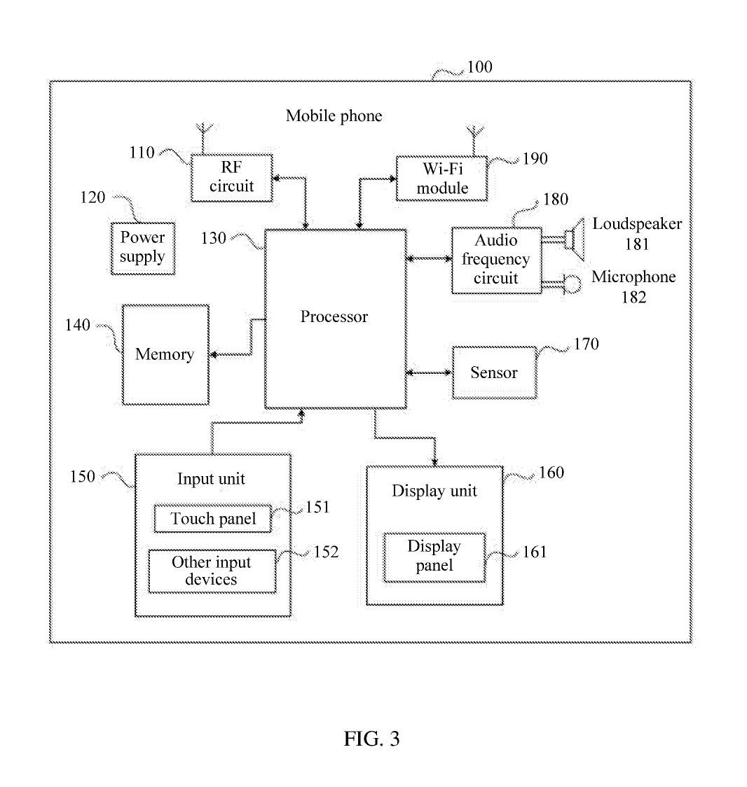

As shown in FIG. 3, a terminal 100 provided in Embodiment 3 of the present disclosure includes components such as a radio frequency (Radio Frequency, RF) circuit 110, a power supply 120, a processor 130, a memory 140, an input unit 150, a display unit 160, a sensor 170, an audio frequency circuit 180, and a Wireless Fidelity (WiFi) module 190. A person skilled in the art can understand that a structure of the terminal shown in FIG. 3 does not constitute a limitation on the terminal, and the terminal may include more or fewer components than those shown in the figure, or a combination of some components, or the components disposed differently.

The following describes in detail constituent parts of the terminal 100 with reference to FIG. 3.

The RF circuit 110 may be configured to send and receive a signal in an information receiving and sending or calling process. In particular, after receiving downlink information of a base station, the RF circuit 110 sends the downlink information to the processor 130 for processing. In addition, the RF circuit 110 sends uplink data to the base station. Generally, the RF circuit includes but is not limited to an antenna, at least one amplifier, a transceiver, a coupler, a low noise amplifier (LNA), a duplexer, and the like. In addition, the RF circuit 110 may also communicate with a network and another device through radio communication. Any communications standard or protocol may be used for the radio communication, including but not limited to Global System for Mobile Communications (GSM), general packet radio service (GPRS), Code Division Multiple Access (CDMA), Wideband Code Division Multiple Access (WCDMA), Long Term Evolution (LTE), an email, short message service (SMS), and the like.

The memory 140 may be configured to store a software program and a module. The processor 130 runs the software program and the module that are stored in the memory 140 to execute various functions and applications and data processing of the terminal 100. The memory 140 may mainly include a program storage area and a data storage area. The program storage area may store an operating system, an application program required by at least one function (for example, a voice playback function and a picture playback function), and the like. The data storage area may store data (for example, audio frequency data and a phone book) created based on usage of the terminal 100, and the like. In addition, the memory 140 may include a high-speed random access memory, or may further include a non-volatile memory, such as at least one magnetic disk storage device, a flash storage device, or another volatile solid-state storage device.

The input unit 150 may be configured to receive input digital or character information and generate key signal input related to user setting and function control of the terminal 100. In an embodiment, the input unit 150 may include a touch panel 151 and another input device 152. The touch panel 151, also referred to as a touchscreen, may collect a touch operation performed by a user on or near the touch panel 151 (for example, an operation performed on or near the touch panel 151 by the user using a finger, a stylus, or any other suitable object or accessory), and drive a corresponding connected apparatus according to a preset program. Optionally, the touch panel 151 may include two parts a touch detection apparatus and a touch controller. The touch detection apparatus detects a touch direction of a user, detects a signal brought by a touch operation, and transmits the signal to the touch controller. The touch controller receives touch information from the touch detection apparatus, converts the touch information into contact coordinates, and sends the contact coordinates to the processor 130, and can receive a command sent by the processor 130 and execute the command. In addition, the touch panel 151 may be implemented in a plurality of types, such as a resistive type, a capacitive type, an infrared type, and a surface acoustic wave type. In addition to the touch panel 151, the input unit 150 may further include another input device 152. In an embodiment, the another input device 152 may include but is not limited to one or more of a physical keyboard, a function key (such as a volume control key or a switch key), a trackball, a mouse, and a joystick.

The display unit 160 may be configured to display information input by the user, information provided for the user, and various menus of the terminal 100. The display unit 160 may include a display panel 161. Optionally, the display panel 161 may be configured in a form of a liquid crystal display (LCD), an organic light emitting diode (OLED), or the like. Further, the touch panel 151 may cover the display panel 161. After detecting a touch operation on or near the touch panel 151, the touch panel 151 sends the touch operation to the processor 130 to determine a touch event type. Then, the processor 130 provides corresponding visual output on the display panel 161 based on the touch event type. Although in FIG. 1, the touch panel 151 and the display panel 161 are used as two independent components to implement input and output functions of the terminal 100, in some embodiments, the touch panel 151 and the display panel 161 may be integrated to implement the input and output functions of the terminal 100.

The terminal 100 may further include at least one sensor 170, such as a light sensor, a motion sensor, and another sensor. In an embodiment, the light sensor may include an ambient light sensor and a proximity sensor, where the ambient light sensor may adjust luminance of the display panel 161 based on a degree of ambient light, and the proximity sensor may turn down the display panel 161 and/or backlight when the terminal 100 moves close to an ear. As a type of motion sensor, an accelerometer sensor may detect acceleration magnitudes in all directions (generally three axes), may detect a magnitude and a direction of gravity when the accelerometer sensor is stationary, and may be configured to recognize a posture application of the terminal (such as switching between a landscape mode and a portrait mode, related games, and magnetometer posture calibration), a vibration related function (such as a pedometer and stroke), and so on. As regards other sensors that may be further configured for the terminal 100, such as a gyroscope, a barometer, a hygrometer, a thermometer, and an infrared sensor, details are not described herein.

The audio frequency circuit 180, a loudspeaker 181, and a microphone 182 may provide an audio frequency interface between the user and the terminal 100. The audio frequency circuit 180 may transmit, to the loudspeaker 181, an electrical signal converted from received audio data. The loudspeaker 181 converts the electrical signal into an audio signal and outputs the audio signal. In addition, the microphone 182 converts the collected audio signal into an electrical signal. The audio frequency circuit 180 receives the electrical signal, converts the electrical signal into audio data, and then outputs the audio data to the RF circuit 110, to send the audio data to another terminal, or outputs the audio data to the memory 140 for further processing. Although FIG. 1 shows the audio frequency circuit 180, the loudspeaker 181, and the microphone 182, it can be understood that they do not belong to necessary constituents of the terminal 100 and may be omitted based on a requirement without changing the scope of essence of the present disclosure.

Wi-Fi belongs to a short-range wireless transmission technology, and the terminal 100 may help, using the Wi-Fi module 190, the user to send and receive an e-mail, browse a web page, access streaming media, and the like. Wi-Fi provides wireless broadband Internet access for the user. Although FIG. 1 shows the Wi-Fi module 190, it can be understood that the Wi-Fi module 190 does not belong to a necessary component of the terminal 100 and may be omitted based on a requirement, without changing the scope of essence of the present disclosure.

In this embodiment, the RF circuit 110 is configured to send and receive information, and the information includes an SMS message and voice information.

The memory 140 is configured to store historical information that is received and sent by the RF circuit 110.

The processor 130 is configured to obtain abstract information of to-be-verified information and an identification code from the RF circuit 110 or the memory 140.

The abstract information may be information generated using key information extracted from the to-be-verified information, and is used to represent the to-be-verified information. In this case, when the to-be-verified information is excessively long, a data volume for information sending and storage is decreased. Before sending the information for security verification or before performing information security verification, an information security verification apparatus needs to negotiate a generation manner of the abstract information of the to-be-verified information with a server. The server is a sender identified by a to-be-verified identification code in a to-be-verified identification code list. In this way, the terminal generates abstract information from the to-be-verified information in the negotiated generation manner of the abstract information such that the server can identify the abstract information and reversely deduce content of the to-be-verified information based on the negotiated generation manner of the abstract information, thereby ensuring verifiability of the abstract information.

The identification code is used to identify a sender that sends the to-be-verified information to the terminal. The to-be-verified information is information from a to-be-verified sender, and the to-be-verified sender includes a sender with a preset identification code. The preset identification code may be set by the user of the terminal as required, and the identification code may be generally set to be an identification code of a sending source, such as a bank, a securities company, or an operator. For example, an identification code of China Mobile Communications is 10086 and an identification code of China Merchants Bank is 95555.

The memory 140 is further configured to store a to-be-verified identification code list, and the to-be-verified identification code list stores an identification code that needs to be verified. The processor 130 initiates an information security verification request when the RF circuit 110 receives information from a sender identified by the identification code that needs to be verified in the to-be-verified identification code list. The to-be-verified identification code list is input in advance as required by the user of the terminal using the input unit 150.

The processor 130 is further configured to send the information security verification request to the server based on the identification code using the RF circuit 110. The server is a sender identified by the identification code, and the information security verification request includes the abstract information of the to-be-verified information.

The memory 140 is configured to store a server list that is maintained by the information security verification apparatus, and the server list is collected from various servers by the information security verification apparatus or a developer of the server list. The server list includes an identification code, a server, and an address of a server, and the server is a sender identified by the to-be-verified identification code in the to-be-verified identification code list.

The processor 130 is further configured to obtain, based on the identification code and the server list, an address of a server corresponding to the identification code to send the information security verification request to the server based on the address of the server using the communications apparatus of the terminal.

The RF circuit 110 is configured to receive a matching result of the server such that the processor 130 can determine, using the matching result, whether the to-be-verified information is sent by the server identified by the identification code of the to-be-verified information. If the to-be-verified information is sent by the server identified by the identification code of the to-be-verified information, the to-be-verified information is “authentic”. If the to-be-verified information is not sent by the server identified by the identification code of the to-be-verified information, the to-be-verified information is “fake”, and the display unit 160 displays the result to the user of the terminal. In this way, security verification on information exchanged between the terminal and the server is implemented.

It can be learned that, in the foregoing embodiment of the present disclosure, the information security verification apparatus is disposed in the terminal, a sending source of received important information may be selectively identified based on a user-preset identification code list that needs to be verified, and an identification request is sent back to the sending source of the important information using an identification code carried in the important information to verify authenticity of the source of the important information, and also avoid a waste of terminal resources due to verification of some unimportant information.

In the foregoing specific implementations, the objective, technical solutions, and benefits of the present disclosure are further described in detail. It should be understood that the foregoing descriptions are merely specific implementations of the present disclosure, but are not intended to limit the protection scope of the present disclosure. Any modification, equivalent replacement, or improvement made without departing from the spirit and principle of the present disclosure shall fall within the protection scope of the present disclosure.

What is claimed is:

1. A terminal, comprising:
a memory configured to:
store instructions; and
store historical information received by the terminal; and
a processor coupled to the memory and configured to execute the instructions, which cause the processor to be configured to:
obtain abstract information of to-be-verified information and an identification code from the historical information, wherein the identification code identifies a sender that sends the to-be-verified information to the terminal; and
send an information security verification request to the sender, wherein the information security verification request comprises the abstract information of the to-be-verified information; and
receive a verification result from the sender, wherein the verification result indicates whether the sender has previously sent information that matches the to-be-verified information.

2. The terminal according to claim 1, wherein the memory is further configured to store a to-be-verified identification code list comprising the identification code that needs to be verified.

3. The terminal according to claim 2, wherein the instructions further cause the processor to be configured to initiate sending the information security verification request in response to receiving first information from the sender identified by the identification code that needs to be verified, wherein the to-be-verified identification code list comprises the identification code of the sender.

4. The terminal according to claim 1, wherein the abstract information is information generated based on key information in the to-be-verified information, and wherein the abstract information is used to represent the to-be-verified information.

5. The terminal according to claim 2, wherein the instructions further cause the processor to be configured to:
negotiate a generation manner of the abstract information of the to-be-verified information with a server; and
generate the abstract information based on the generation manner of the abstract information and the to-be-verified information, wherein the server is the sender identified by the to-be-verified identification code in the to-be-verified identification code list.

6. The terminal according to claim 2, wherein the memory is further configured to store a server list comprising an identification code, a server, and an address of the server, wherein the server is the sender identified by the to-be-verified identification code in the to-be-verified identification code list; and wherein the instructions further cause the processor to be configured to obtain the address of the server corresponding to the identification code based on the identification code and the server list to send the information security verification request to the server based on the address of the server.

7. An information security verification method, comprising:
obtaining, by a terminal, abstract information of to-be-verified information and an identification code, wherein the identification code identifies a sender that sends the to-be-verified information to the terminal;
sending an information security verification request to the sender of the to-be-verified information based on the identification code, wherein the information security verification request comprises the abstract information of the to-be-verified information; and
receiving a verification result from the sender, wherein the verification result indicates whether the sender has previously sent information that matches the to-be-verified information.

8. The information security verification method according to claim 7, wherein before obtaining the abstract information of the to-be-verified information and the identification code, the method further comprises determining whether first information received by the terminal is the to-be-verified information based on a to-be-verified identification code list, wherein the to-be-verified identification code list stores an identification code that needs to be verified.

9. The information security verification method according to claim 8, wherein determining, based on the to-be-verified identification code list, whether the first information received by the terminal is the to-be-verified information comprises:
extracting a sender identification code carried in the first information in response to the terminal receiving the first information; and
determining whether the sender identification code is recorded in the to-be-verified identification code list, wherein the first information is the to-be-verified information, wherein the sender identification code is recorded in the to-be-verified identification code list.

10. The information security verification method according to claim 7, wherein before obtaining the abstract information of to-be-verified information and identification code, the method further comprises:
negotiating a generation manner of the abstract information of the to-be-verified information with a server; and
generating the abstract information based on the generation manner and the to-be-verified information, wherein the server is a sender identified by the to-be-verified identification code in the to-be-verified identification code list.

11. The information security verification method according to claim 7, wherein sending the information security verification request to the sender of the to-be-verified information based on the identification code comprises obtaining an address of a server corresponding to the identification code based on the identification code and a server list to send the information security verification request to the server based on the address of the server, wherein the memory is further configured to store the server list, and wherein the server list comprises the identification code, the server, and the address of the server, wherein the server is a sender identified by the to-be-verified identification code in the to-be-verified identification code list.

12. An information security application method, comprising:
obtaining abstract information of to-be-verified information and an identification code, wherein the identification code identifies a sender that sends the to-be-verified information to a terminal;
sending an information security verification request to the sender of the to-be-verified information based on the identification code, wherein the information security verification request comprises the abstract information of the to-be-verified information; and
receiving a verification result from the sender, wherein the verification result indicates whether the sender has previously sent information that matches the to-be-verified information.

13. The information verification system according to claim 12, further comprising storing a to-be-verified identification code list comprising the identification code that needs to be verified.

14. The information verification system according to claim 13, further comprising initiating sending of the information security verification request in response to the terminal receiving first information from the sender identified by the identification code that needs to be verified in the to-be-verified identification code list.

15. A terminal, comprising:
a memory configured to store historical information that is received and sent by the RF circuit;
a processor coupled to the memory and configured to obtain abstract information of to-be-verified information and an identification code from the historical information, wherein the identification code identifies a sender that sends the to-be-verified information to the terminal, and
a radio frequency (RF) circuit coupled to the processor and configured to:
send an information security verification request to the sender, wherein the information security verification request comprises the abstract information of the to-be-verified information; and
receive a verification result from the sender, wherein the verification result indicates whether the sender has previously sent information that matches the to-be-verified information.

16. The terminal according to claim 15, wherein the memory is further configured to store a to-be-verified identification code list comprising the identification code that needs to be verified.

17. The terminal according to claim 15, wherein the processor is configured to initiate the information security verification request in response to the terminal receiving first information from the sender identified by the identification code that needs to be verified in a to-be-verified identification code list.

18. The terminal according to claim 15, wherein the abstract information is information generated based on key information in the to-be-verified information, and wherein the abstract information is used to represent the to-be-verified information.

19. The terminal according to claim 15 wherein the processor is configured to:
negotiate a generation manner of the abstract information of the to-be-verified information with a server; and
generate the abstract information based on the generation manner and the to-be-verified information, wherein the server is the sender identified by the to-be-verified identification code in the to-be-verified identification code list.

20. The terminal according to claim 15, wherein the memory is configured to store a server list comprising the identification code, a server, and an address of the server, wherein the server is the sender identified by the to-be-verified identification code in the to-be-verified identification code list, and wherein the processor is configured to obtain the address of the server corresponding to the identification code based on the identification code and the server list to send the information security verification request to the server using the RF circuit and based on the address of the server.
